(19) United States
(12) Patent Application Publication
(10) Pub. No.: US 2025/0285049 A1
(43) Pub. Date: Sep. 11, 2025

(54) SYSTEM AND METHOD FOR ENHANCED TASK MANAGEMENT AND PRIORITIZATION

(71) Applicant: Craig Wenger, Chandler, AZ (US)

(72) Inventor: Craig Wenger, Chandler, AZ (US)

(21) Appl. No.: 19/045,237

(22) Filed: Feb. 4, 2025

Related U.S. Application Data
(60) Provisional application No. 63/563,321, filed on Mar. 9, 2024.

(51) Int. Cl. G06Q 10/0631

(52) U.S. Cl. CPC G06Q 10/063116

(57) ABSTRACT

Tasks may be prioritized based on dynamic priority adjustments, which may adjust the priority based on time and/or location. Task data may include task type, completion date, task priority, and task location. The task type may be a due-by task (which can be adjusted in priority over time, increasing in priority as the completion date approaches) or a do-on task (which may be a priority upon the completion date). Tasks having a location may be prioritized/activated based on a user's proximity to the task location, and may be deactivated when the distance from the task location exceeds a predetermined threshold. Tasks may be displayed based on the adjusted task priority (and, if appropriate, proximity to the task location). Alerts may be generated based on the adjusted task priority (and proximity to the task location). Tasks may be grouped for display based on category.

### COPYRIGHT AND TRADEMARK STATEMENT

A portion of the disclosure of this patent document may contain material that is subject to copyright protection. The copyright owner(s) has no objection to the facsimile reproduction by anyone of the patent document or the patent disclosure as it appears in the Patent and Trademark Office patent file or records, but otherwise reserves all copyright rights whatsoever. Trademarks may be used in the present disclosure, and the applicant(s) make no claim to any trademarks referenced.

### PRIORITY STATEMENT

This application claims priority to U.S. Provisional Application No. 63/563,321 filed 2024 Mar. 9, which is incorporated herein by reference.

### FIELD OF THE INVENTION

The invention relates in general to the field of computer applications for managing and prioritizing tasks that a user is to complete.

### BACKGROUND OF THE INVENTION

Across a wide range of society, people are constantly looking for ways to be more efficient with their time. Everyone has too much to do and too little time to do it in. It is also challenging to balance competing priorities across various aspects of life when the inevitable tradeoffs are necessary. Various tools exist to help manage a busy life. Such tools include calendar, task management and to-do style apps, but they all have limitations that make them less than ideal.

Task management is a common challenge faced by individuals and organizations alike. In the modern world, people often have to juggle multiple tasks across various aspects of their lives, including work, family, social commitments, and personal projects. This can lead to a deluge of tasks that can be difficult to manage and prioritize effectively.

Various tools and systems have been developed to assist with task management. These tools typically allow users to create, categorize, and prioritize tasks, and often provide reminders or alerts as task deadlines approach. Some of these tools also offer the ability to group tasks by category or project, and to assign tasks to specific dates or times.

Task types having a completion date can generally be categorized into two main groups: tasks that are due by a specific date and time, and tasks that are to be done on a specific date and time. The former type of tasks can be completed at any time before the completion date, while the latter type of tasks can be completed at the specified date and time. Other tasks may not have a specified completion date, but such tasks typically can be considered as lower priority than those which do have a completion date.

Despite the availability of these tools and systems, task management remains a complex and challenging task. The effectiveness of these tools often depends on the user's ability to accurately categorize, prioritize, and schedule tasks, and to keep track of multiple tasks across various aspects of their lives.

Herein is presented a new solution including several novel features that seek to provide enhanced time and task management balancing competing priorities to ensure that the most relevant and important tasks are always completed. The features and advantages of the present invention will become more readily apparent from the attached drawings and the detailed description of the illustrated embodiments, which follow.

### SUMMARY OF THE INVENTION

Bearing in mind the problems and deficiencies of existing systems and methods, it is therefore an object of the present invention to provide a system and method for managing and prioritizing tasks that dynamically adjusts task priority according to the current situation, which may include the current date and/or time and/or the current location of the user.

A task management system may employ a task input module, a dynamic priority module, and a task display module. The task input module may be programmed to allow a user to input task data for a plurality of tasks; such task data for each task may include a task type (such as a due-by task or a do-on task), a task completion date/time, and an initial task priority level. The dynamic priority module may be programmed to adjust the task priority level of at least a subset of the tasks to provide an adjusted task priority level for each such task based, at least partly, on the current date/time, as well as on the task type. For due-by tasks, the dynamic priority module may operate to increase the task priority level of each due-by task as the current date/time approaches the task completion date/time for such tasks. For do-on tasks, the dynamic priority module may operate to increase the task priority level of each do-on task when the current date/time matches the task completion date/time within a specified threshold. The task display module may be programmed to display at least a subset of the tasks to be completed to the user, and may including at least one display mode in which some or all of the tasks are presented in order based on their adjusted task priority levels.

The task input module may programmed to allow a user to input, for at least a subset of tasks, an associated task location. In such cases, the system can further include a location-based module that receives information on the current location of the user and adjusts the information provided via the task display module based, at least in part, on the current location of the user compared to the task location(s). In at least one mode of operation of such a system, the information provided via the task display module is adjusted to prevent display of at least a subset of tasks having task locations that do not match the current location of the user within a prescribed threshold.

A task management system may employ a task input module, a location-based module, a dynamic priority module, and a task display module. The task input module may be programmed to allow a user to input task data for a plurality of tasks, such task data for each task including an initial task priority level, and including for at least a subset of tasks an associated task location. The location-based module may receives information on the current location of the user, and the dynamic priority module may be programmed to adjust the task priority level of at least a subset of tasks to provide an adjusted task priority level for each task having an associated task location, such adjustment being based at least in part on a comparison of the current location of the user with the task location; the dynamic priority module may operate to increase the task priority level of each task having an associated location when the current location of the user matches the task location within a prescribed threshold. The task display module may be programmed to display at least a subset of the tasks to be completed to the user, and include at least one display mode in which at least a subset of the tasks is presented in order based on their adjusted task priority levels.

The system may have at least one mode of operation where the information provided via the task display module is adjusted to prevent display of at least a subset of tasks having task locations that do not match the current location of the user within a prescribed threshold.

The task input module may be programmed to allow a user to input, for at least a subset of tasks, a task completion date/time and a task type (selected as either a due-by task or a do-on task), further wherein the dynamic priority module may be programmed to adjust the task priority level of at least a subset of the tasks to provide an adjusted task priority level for each such task based, at least partly, on the current date/time, as well as on the task type. For due-by tasks, the dynamic priority module may operate to increase the task priority level of each due-by task as the current date/time approaches the task completion date/time for such tasks. For do-on tasks, the dynamic priority module may operate to increase the task priority level of each do-on task when the current date/time matches the task completion date/time within a specified threshold.

For any of the above systems, the system may include a notification module that is programmed to provide alerts to the user of at least one task having an adjusted task priority level that exceeds a prescribed threshold. Where the system has a location-based module, the system may include a notification module programmed to provide alerts to the user of at least one task having an adjusted task priority level that exceeds a prescribed threshold and which has a task location that matches the current location of the user within a prescribed threshold.

The system may allow the task data input by the user to include a task category, and the task display module may be programmed to display, in at least one mode of operation, at least a subset of tasks based on at least one task category.

The task input module may be further programmed to allow a user to input a task completion status with respect to each task, and the task display module may be further programmed to display, in at least one mode of operation, at least a subset of tasks with any tasks having a completed task status being excluded from display.

A method for managing and prioritizing tasks may include the steps of receiving input that includes task data for a plurality of tasks, adjusting the task priority level of at least a subset of tasks to provide an adjusted task priority level, and displaying to the user at least a subset of the tasks to be completed. In the step of receiving input that includes task data for a plurality of tasks, such task data for each task may include a task completion date/time, an initial task priority level, and at least one task priority adjustment criterion selected from the group of a task type (selected as either a due-by task or a do-on task) and a task location. The step of adjusting the task priority level of at least a subset of tasks to provide an adjusted task priority level for each such task may adjust the priority level based, at least partly, on the at least one task priority adjustment criterion for each such task, and such adjustment may including at least one adjustment from the group of increasing the task priority level of each due-by task as the current date/time approaches the task completion date/time for such tasks, increasing the task priority level of each do-on task when the current date/time matches the task completion date/time for such tasks within a specified threshold, and increasing the task priority level of each task having an associated location when the current location of the user matches the task location within a prescribed threshold. The step of displaying to the user at least a subset of the tasks to be completed, in at least one display mode, may include presenting at least a subset of the tasks based on their adjusted task priority levels.

When the task data received in the step of receiving input from a user includes a task location for at least a subset of the tasks, the step of displaying to the user at least a subset of the tasks may include at least one mode of operation in which at least a subset of tasks having task locations that do not match the current location of the user within a prescribed threshold are excluded from display.

The method may further include the step of providing alerts to the user of at least one task having an adjusted task priority level that exceeds a prescribed threshold. Where the task data includes a task location, the method may include the step of providing alerts to the user of at least one task having an adjusted task priority level that exceeds a prescribed threshold and having a task location that matches the current location of the user within a prescribed threshold.

The task data input by the user may include a task category, and the step of displaying to the user at least a subset of the tasks, in at least one mode of operation, may include adjusting the display based on at least one task category.

The method may include the step of allowing a user to input a task completion status with respect to each task, in which case the step of displaying to the user at least a subset of the tasks, in at least one mode of operation, may include excluding any tasks having a completed task status from display.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. When reference is made to a reference numeral without specification to an existing sub-label, it is intended to refer to all such multiple similar components.

FIG. 1A is a block diagram showing the components of one embodiment of a task management and prioritization system, which incorporates a smart device to perform many of the functions.

FIG. 1B is a block diagram of one example of a Task Input Module.

FIG. 1C is a block diagram of one example of a Dynamic Priority Module.

FIG. 1D is a block diagram of one example of a Location-Based Module.

FIG. 2A is a flowchart showing one example of a method for managing and prioritizing tasks.

FIG. 2B is a flowchart showing one example of steps for adjusting priority of a task based on current time.

FIG. 2C is a flowchart showing one example of steps for adjusting priority and/or display of a task based on current location.

Corresponding reference characters indicate corresponding parts throughout the several views. The examples set out herein illustrate embodiments of the invention and such examples are not to be construed as limiting the scope of the invention in any manner.

### DETAILED DESCRIPTION

While various aspects and features of certain embodiments have been summarized above, the following detailed description illustrates a few examples of embodiments in further detail to enable one skilled in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art however that other embodiments of the present invention may be practiced without some of these specific details. Several embodiments are described herein, and while various features are ascribed to different embodiments, it should be appreciated that the features described with respect to one embodiment may be incorporated with other embodiments as well. By the same token however, no single feature or features of any described embodiment should be considered essential to every embodiment of the invention, as other embodiments of the invention may omit such features.

In this application the use of the singular includes the plural unless specifically stated otherwise and use of the terms “and” and “or” is equivalent to “and/or,” also referred to as “non-exclusive or” unless otherwise indicated. Moreover, the use of the term “including,” as well as other forms, such as “includes” and “included,” should be considered non-exclusive. Also, terms such as “element” or “component” encompass both elements and components including one unit and elements and components that include more than one unit, unless specifically stated otherwise.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps or acts are in some way inherently mutually exclusive.

In the present discussion, “date”, “time”, or “date/time” may be used interchangeably. Depending on the particular user needs, tasks may be associated with a date of completion, a time of completion, or a combination of date and time. Similarly, time-based adjustment may be performed based on current date, current time, or combined current date and time. Any of these terms should be interpreted as covering all three options as suitable for a particular application.

As this invention is susceptible to embodiments of many different forms, it is intended that the present disclosure be considered as an example of the principles of the invention and not intended to limit the invention to the specific embodiments shown and described.

Many people have more to do than they have time to accomplish it. In addition, keeping track of many tasks across all aspects of life can be challenging. The human mind can only keep track of so many things and the combination of commitments for family, work, social circles, community, and any other spheres of life can result in a deluge of “things” to do. There is a need to ensure that the important things are done when needed and to keep track of tasks to be as efficient as possible with one's time. people often have to juggle multiple tasks across various aspects of their lives, including work, family, social commitments, and personal projects. This can lead to a deluge of tasks that can be difficult to manage and prioritize effectively.

Various tools and systems have been developed to assist with task management. Current tools that are commonly used include various task management, to do list, or calendar apps, which operate on one or more computer devices of the user. These tools typically allow users to add tasks with various due/completion dates and times, and may allow users to categorize and prioritize tasks, and often provide reminders or alerts as task deadlines approach. Some of these tools also offer the ability to group tasks by project. Some provide ways to aggregate tasks into groups or by day to help narrow the focus, but none of them are very good at answering the fundamental question for a user as to what task to undertake next. At any given moment, a user can open existing applications and see many tasks that need to be done, but without guidance as to which task should be done next. The user is left to sort through what is displayed and choose one of the available tasks by trying to weigh all the competing factors. Despite the availability of existing tools and systems, task management remains a complex and challenging task. The effectiveness of existing tools often depends on the user's ability to accurately categorize, prioritize, and schedule tasks, and to keep track of multiple tasks across various aspects of their lives. This may be exhausting and inefficient.

The present system and method, in some embodiments, can provide guidance to the user in answering the fundamental question of what they should do next. The system and method may provide a place where a user can see exactly what task should be completed next. The system and method may be designed to indicate to the user with precisely what task should be done at any time.

Task types having a specified required completion date can generally be categorized into two main groups: tasks that are due to be completed by a specific date and time (“due-by tasks”), and tasks that are to be done on a specific date and time (“do-on tasks”). The former type of tasks can be completed at any time before the due date (herein, “task completion date” is used to refer to the due date that a task must be completed, rather than when it actually is completed), while the latter type of tasks can only be completed at the specified date and time. Some tasks may not have a specified completion date/time, and thus are typically considered to have a lower priority than those which do have a completion date/time. The system and method could ignore such tasks or could be designed to include such tasks, but treat them as having a low priority level. Such tasks are generally not addressed in the following discussion for conciseness.

Task priority is another common feature in task management systems. This allows users to assign a level of urgency or priority to each task, which can help in determining the order in which tasks are to be completed. However, in earlier systems and methods the priority of a task is typically static and does not change over time. In the present system and method, the priority level of a task (particularly a due-by task) may be increased as the required completion date approaches.

The present system and method may also adjust priority using location-based task management, where some or all tasks are associated with specific geographical locations where the task is to be completed. The system or method can then use data regarding the current location of the user to adjust priority level and/or determine which tasks are relevant at any given time. This can be particularly useful for tasks that can or have to be completed at specific locations.

A due-by task is something that can be worked over time and/or which can be completed at any point prior to the completion date. These types of tasks include actions such as preparing a sales presentation for a meeting next Friday, dropping off donations at a thrift store, completing a term paper for school, or purchasing a birthday gift for a friend. All of these can be completed on the day they are due but can also be completed prior to that day if possible. In some cases, these types of tasks can be worked intermittently with time spent across multiple days working to prepare that sales presentation or write that term paper. In the case of these types of tasks, those having a sufficiently high priority level should appear on the list every day until they are complete, providing a reminder of the task itself and an opportunity to work on or complete the task each day.

A do-on task is one that can only be completed on the date and/or time that it is scheduled. These types of tasks include actions such as a dentist appointment, a scheduled meeting with a colleague, a lunch appointment with a friend, or a flight to a conference. The defining feature of do-on type of tasks is that they are typically not important or relevant until the day that they are due. As such, it is often not helpful to include these on a list of tasks until the day that they are to be completed. If a user has a dentist appointment tomorrow, it will typically not be the next thing the user should do today, so it should not appear on the user's task list today.

The present system and/or method may adjust the task priority level dynamically, based on time. The concept of time-based dynamic priority is fairly simple—the priority level of a task increases over time, as the completion date/time approaches. This is relevant to due-by tasks such as the term paper mentioned above. If the task is entered 3 weeks before the due date of the paper, the priority level may be low at that time. However, as the due date approaches, that priority level should increase and, on the day before it is due, it should be a very high priority level if it is not yet complete. This dynamic priority impacts the task list because, if it is still 3 weeks until the paper is due, many other tasks may be more important today and should be completed first. But on the day before the paper is due, that task should be at the top of the list to make sure it gets the necessary focus to complete (for simplicity, this discussion assumes that the paper is a task that should take less than one day to complete; estimated time to complete a task can be taken into account when making the time-based priority level adjustment). Both the initial and final priority levels are user adjustable, as are the timing of intermediate steps if desired. This provides the user a method to optimally tune the dynamic priority to reflect the needs of the task and ensure it is prioritized appropriately for any point up to and including the due date.

The present system and/or method may adjust the task priority level dynamically based on the current location of the user, either alone or in combination with time-based adjustment of priority level. Such location-based adjustment allows the user to assign a physical location on the map to a particular task. When enabled, the task is assigned a location and relevant radius within which that task is active (or considered to have an elevated priority level). Any time the user is outside of this area, such as determined by location services on their mobile device, the task will not appear on the list (or will appear at a lower priority level). If the user is within the location of the task, the task is eligible to appear on the list based on the other criteria above. So even if a task is high priority, if it is assigned a location and the user is not at that location, it may not appear on the list. This allows the user to separate home and work tasks, add specific tasks for the gym or grocery store, or otherwise ensure that tasks specifically associated with a particular location do not clutter the list if the user is not at that location. Alternatively, tasks having a sufficiently high priority and/or tasks within a certain category (or simply tasks designated as being exempt from location-based adjustment) may appear even when outside the designated area. Proximity to the location could be determined by absolute distance (such as available by GPS, cellular tower identification, or similar conventional locating techniques) or by estimated travel time and/or distance (such as available from mobile mapping/navigation applications). Locations could be specific locations, such as the office or home of the user, or could be types of locations, such as grocery stores.

Some or all of the above features may include standard capabilities such as task naming and completion dates/times to populate an active list of tasks at any given moment. This list can be filtered for due-by vs. do-on tasks and/or by location, and then prioritized based on static and dynamic priorities as of the current date (and current user location, where applicable).

The result is a list that provides the answer to the fundamental question of what task the user should undertake next. The user need simply to look at the task at the top of the list at any moment and know that this is the best task on which to focus their energy at that time. As tasks are completed and checked off the list, lower priority tasks can be done. If the user moves to a different location, other tasks may become relevant and appear on the list in relative priority order. Again, this means that at any moment, the user can look at this list and know that they are working the most relevant, most important task on their list.

As this system and method are susceptible to embodiments of many different forms, it is intended that the present disclosure be considered as an example of the principles of the invention and not intended to limit the invention to the specific embodiments shown and described.

The present disclosure pertains to the field of task management systems, and more specifically, discloses systems and methods for managing and prioritizing tasks based on dynamic priority adjustments and/or location-based activation. Task management is a common challenge faced by individuals and organizations alike, with the modern world often requiring the juggling of multiple tasks across various aspects of life, including work, family, social commitments, and personal projects. This can lead to a deluge of tasks that can be difficult to manage and prioritize effectively.

In some aspects, the present disclosure provides a task management and prioritizing system that includes a task input module programmed to receive task data. This data may include a task type selected from a group consisting of a due-by task and a do-on task, a task completion date (and perhaps time), a task priority, and in some cases a task location. The system may also include a dynamic priority module programmed to adjust the task priority over time for the due-by task, and a location-based module programmed to activate the task based on a user's proximity to the task location. Furthermore, the system may include a task display module programmed to display the task based on the adjusted task priority and the user's proximity to the task location. The task management system may provide several benefits. For instance, the dynamic adjustment of task priority over time for due-by tasks can help ensure that tasks are prioritized appropriately as their completion dates approach. This can help users manage their tasks more effectively and ensure that high-priority tasks are completed on time. Additionally, the location-based activation of tasks can help users manage tasks that are associated with specific locations, ensuring that tasks are displayed and prioritized based on the user's proximity to the task location. This can help users manage their tasks more efficiently, particularly when they are moving between different locations.

In other aspects, the present disclosure provides a method for managing and prioritizing tasks that may include the steps of receiving task data, adjusting the task priority over time for due-by tasks, activating the task based on a user's proximity to the task location, and displaying the task based on the adjusted task priority and the user's proximity to the task location. This method can provide similar benefits to the task management system described above, helping users manage and prioritize their tasks more effectively and efficiently.

In yet other aspects, the present disclosure provides a non-transitory computer-readable medium storing instructions that, when executed by a processor, cause the processor to perform a method for managing and prioritizing tasks. This method may include receiving task data, adjusting the task priority over time for due-by tasks, activating the task based on a user's proximity to the task location, and displaying the task based on the adjusted task priority and the user's proximity to the task location. This can provide a convenient and efficient way to implement the task management method described above, allowing users to manage and prioritize their tasks using a variety of computing devices.

The task management system may include a task input module. This module may be programmed to receive task data, which can include a task type, an initial task priority level, and in some cases a task location. The task type may be selected from a group consisting of a due-by task and a do-on task. In some cases, the task input module may be further programmed to receive a task completion date and/or time. This additional data can provide more context for the task and can be used to inform the dynamic adjustment of the task priority. In some cases, the task input module could be fully or partially integrated with an existing task management application, such as a calendar application, to facilitate entering task information in a manner that the user is already accustomed to.

The task management system may also include a dynamic priority module. This module may be programmed to adjust the task priority over time, at least for the due-by tasks. In some cases, the dynamic priority module may be further programmed to increase the task priority level as the task completion date approaches. This dynamic adjustment of task priority can help ensure that tasks are prioritized appropriately as their completion dates approach, helping users manage their tasks more effectively. Such increase in priority level over time could be a linear increase over time, or could be any curve that is appropriate to the particular task, such as a gradual (or even negligible) increase when the completion date is far in the future and an increasing rate of adjustment as the completion date approaches. In some case, the user may have an option to set a particular due-by task to not have its priority level increase over time.

For do-on type tasks, the dynamic priority module may adjust the priority between two levels, a low priority level where the task is not displayed to the user, and a high priority level on the completion date where the task is displayed to the user (and optionally one or more alerts are provided to the user). Such adjustment would include a scheme where the dynamic priority module or other element directs the task to be hidden from display when the current and task dates do not match, and to allow display when they do match.

In some aspects, the task management system may include a location-based module. This module may be programmed to activate the task based on a user's proximity to the task location. In some cases, the location-based module may be further programmed to deactivate the task based on the user's distance from the task location exceeding a predetermined threshold. This location-based activation and deactivation of tasks can help users manage tasks that are associated with specific locations, ensuring that tasks are displayed and prioritized based on the user's proximity to the task location. Such activation and deactivation could be considered as a two-level form of adjusting the priority level between a lower level (where the task is not displayed to the user) and a higher level (where the task is displayed). In some cases, tasks having a sufficiently high priority level may be displayed even though the user is not within the specified area, to prevent the user from missing important tasks if they happen not to enter the location associated with the high-priority task for some length of time. In some cases, the location-based module may take into account the current time, so as to deactivate tasks associated with a nearby location if that location is closed at the current time. For example, a task associated with a business office or a type of store may remain inactive (lower priority) if the user is located close to the office or type of store but outside of the hours that the office or store is open.

The task management system may also include a task display module. This module may be programmed to display the task based on the adjusted task priority and/or the user's proximity to the task location. The task display module may operate by retrieving the task data from the task input module, including the task type, task priority, task location, and in some cases, task completion status. The task display module may then use this data to determine the order in which tasks are displayed, with tasks having a higher adjusted priority and tasks that are within the user's proximity being displayed first. In some cases, the task input module may be further programmed to receive a task completion status, and the task display module may be further programmed to remove the task from display upon receiving a completed task status. This can help keep the task list up-to-date and focused on the tasks that still require attention. By removing completed tasks from display, the task display module can help ensure that the user's attention is directed towards the tasks that are still pending, helping users manage their tasks more effectively. In some cases, the task display module could be fully or partially integrated with an existing task management application, such as a calendar application, to present the prioritized task display in a manner familiar to the user.

In some aspects, the task management system may further comprise a notification module. This module may be programmed to alert the user of the task based on the adjusted task priority and/or the user's proximity to the task location. The notification module may operate by monitoring the task data, including the adjusted task priority level and the user's proximity to the task location, and generating an alert when the task priority reaches a predetermined threshold and the user is within a predetermined proximity of the task location. The alert may be delivered to the user through various alert systems, including but not limited to email, text, or sound alerts, depending on the urgency of the task. This can provide timely reminders to the user, helping them stay on top of their tasks and manage their time more effectively. The task input module may be further programmed to receive a task category. The task display module may be further programmed to group tasks based on their respective categories. This can help users manage and prioritize their tasks more effectively, particularly when they are dealing with a large number of tasks across various categories.

The notification module may be further programmed to adjust the type and frequency of the alerts based on the adjusted task priority and the user's proximity to the task location. For instance, as the task priority increases and the user gets closer to the task location, the notification module may increase the frequency of the alerts or switch to a more attention-grabbing alert type, such as a sound alert. This can help ensure that the user is aware of the task and can take appropriate action in a timely manner.

A process for managing and prioritizing tasks may include one or more steps for receiving task data, which may include a task type, an initial task priority level, and in some cases a task location. The task type may be selected from a group consisting of a due-by task and a do-on task. In some cases, the task input module may be further programmed to receive a task completion date and/or time. This additional data can provide more context for the task and can be used to inform the dynamic adjustment of the task priority. In some cases, the method may fully or partially integrate the entry of task data with an existing task management process, such as via a calendar application, to facilitate entering task information in a manner that the user is already accustomed to.

The method may also include one or more steps for adjusting the task priority over time, at least for the due-by tasks. In some cases, the dynamic priority module may be further programmed to increase the task priority level as the task completion date approaches. This dynamic adjustment of task priority can help ensure that tasks are prioritized appropriately as their completion dates approach, helping users manage their tasks more effectively. Such increase in priority level over time could be a linear increase over time, or could be any curve that is appropriate to the particular task, such as a gradual (or even negligible) increase when the completion date is far in the future and an increasing rate of adjustment as the completion date approaches. In some case, the user may have an option to set a particular due-by task to not have its priority level increase over time.

For do-on type tasks, the method may essentially adjust the priority between two levels, a low priority level where the task is not displayed to the user, and a high priority level on the completion date where the task is displayed to the user (and optionally one or more alerts are provided to the user). Such adjustment would include a scheme where the dynamic priority module or other element directs the task to be hidden from display when the current and task dates do not match, and to allow display when they do match.

In some aspects, the method may act to elevate the priority level of the task or activate the task based on a user's proximity to the task location. In some cases, the task may be deactivated based on the user's distance from the task location exceeding a predetermined threshold. This location-based activation and deactivation of tasks can help users manage tasks that are associated with specific locations, ensuring that tasks are displayed and prioritized based on the user's proximity to the task location. Such activation and deactivation could be considered as a two-level form of adjusting the priority level between a lower level (where the task is not displayed to the user) and a higher level (where the task is displayed). In some cases, tasks having a sufficiently high priority level may be displayed even though the user is not within the specified area, to prevent the user from missing important tasks if they happen not to enter the location associated with the high-priority task for some length of time. In some cases, the determination of whether to display the task (or to adjust the priority level of the task) may take into account the current time, so as to deactivate tasks associated with a nearby location if that location is closed at the current time. For example, a task associated with a business office or a type of store may remain inactive (lower priority) if the user is located close to the office or type of store but outside of the hours that the office or store is open.

The method may display one or more tasks based on the adjusted task priority of the task(s) and/or based on the user's proximity to the task location(s). The task display may use task data such as the task type, task priority, task location, and in some cases, task completion status to determine the order in which tasks are displayed, with tasks having a higher adjusted priority and tasks that are within the user's proximity being displayed first. The display may exclude a particular task from display upon receiving a completed task status. In some cases, the method may display tasks in a manner fully or partially integrated with an existing task display capability, such as including the tasks in the display(s) available via an existing management application, such as a calendar application.

In some aspects, the method may include providing one or more notifications and/or alerts to the user based on the adjusted task priority and/or the user's proximity to the task location. Such notification could be made in consideration of task data, including the adjusted task priority and the user's proximity to the task location, and an alert could be generated, for example, when the task priority reaches a predetermined threshold and the user is within a predetermined proximity of the task location. The alert may be delivered to the user through various alert systems, including but not limited to email, text, or sound alerts, depending on the urgency of the task. This can provide timely reminders to the user, helping them stay on top of their tasks and manage their time more effectively. The method may receive a task category, in which case tasks may be displayed grouped and/or filtered based on their respective categories. This can help users manage and prioritize their tasks more effectively, particularly when they are dealing with a large number of tasks across various categories.

The method for alerting the user of the task may include adjusting the type and frequency of the alerts based on the adjusted task priority and the user's proximity to the task location. For instance, as the task priority increases and the user gets closer to the task location, the method may increase the frequency of the alerts or switch to a more attention-grabbing alert type, such as a sound alert. This can help ensure that the user is aware of the task and can take appropriate action in a timely manner.

In either a system or method, the task priority level of at least some tasks (typically due-by type tasks) may be adjusted to increase over time. The task priority level may be gradually increased as the task completion date approaches. This dynamic adjustment of task priority level can help ensure that tasks are prioritized appropriately as their completion dates approach, helping users manage their tasks more effectively. This can be particularly useful for tasks that have a high level of urgency or that require a substantial amount of time to complete. By increasing the task priority level as the completion date approaches, the system or method can help ensure that these tasks receive the attention they require in a timely manner.

In some aspects, the task management system or method may allow the user to assign a task category for a particular task. The task category may be a user-defined label or descriptor that helps to categorize the task within a broader context or project. For example, the task category could be “work”, “personal”, “family”, “health”, or any other category that the user finds useful for organizing their tasks. The task category may be entered by the user at the time of task creation, or it may be assigned automatically based on predefined rules or algorithms. The task management system or method may also allow displaying tasks grouped and/or filtered based on their respective categories. For instance, all tasks with the category “work” may be grouped together, separate from tasks with the category “personal”. Alternatively, the display could only show tasks in one or more groups, such that while the user is a at work, “personal” tasks would be hidden, and while at home, “work” tasks might be hidden. Such filtering could be based on factors such as location (whether the user is currently at work or at home), time, and/or other factor relevant to the groups. This grouping and/or filtering can help the user to manage and prioritize their tasks more effectively, particularly when they are dealing with a large number of tasks across various categories. Groups could also be used to set default task locations when receiving task data, such as “work” group tasks being, at least by default, associated with the user's workplace as the task location.

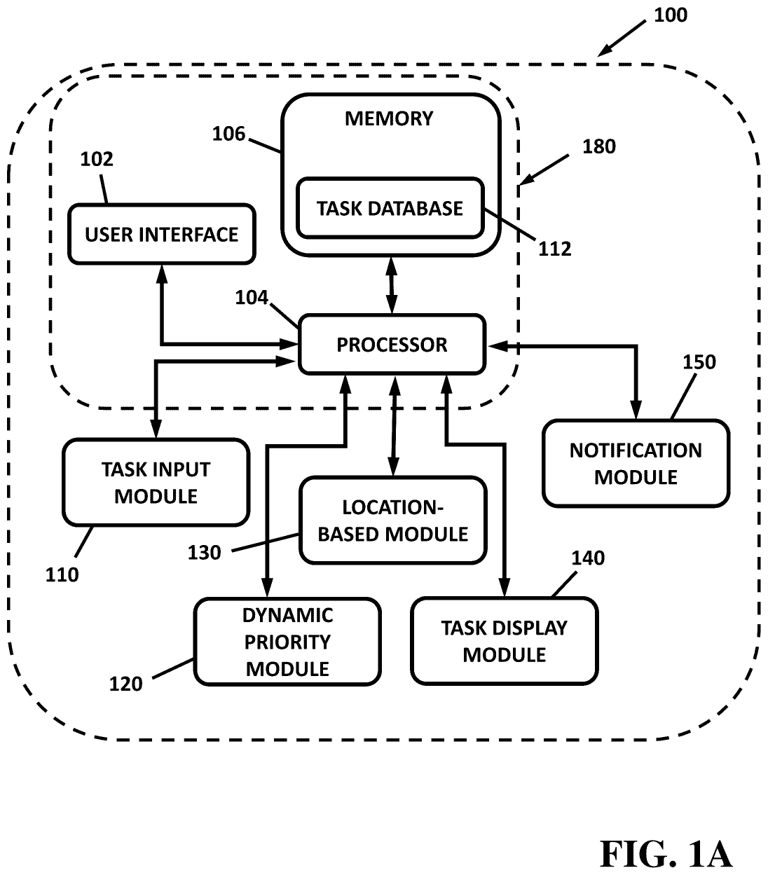

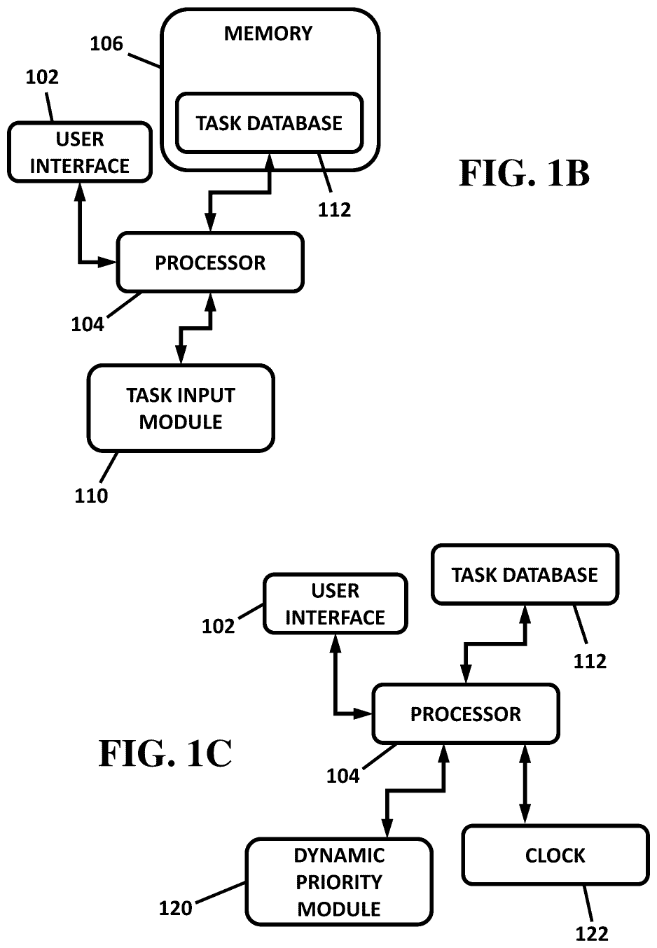

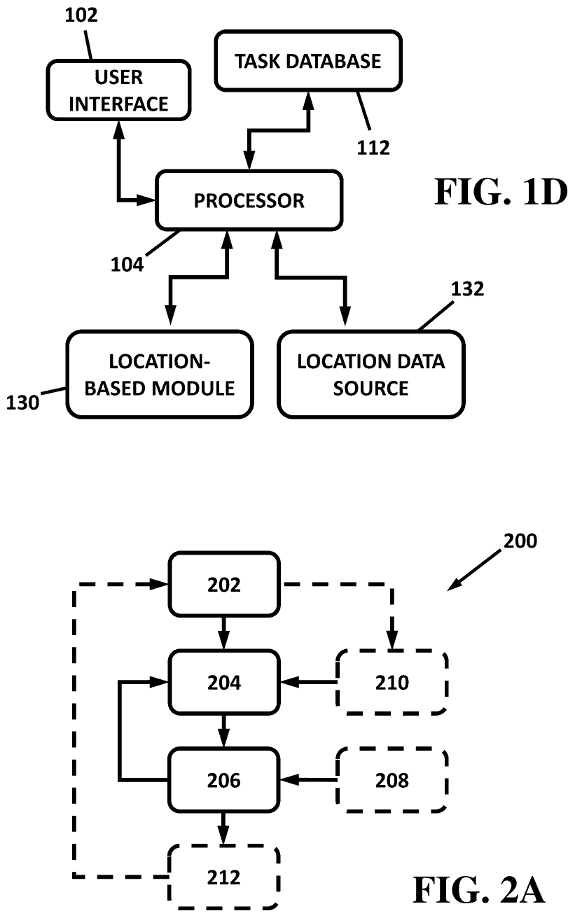

FIG. 1A is a block diagram showing the components of one example of a task management system 100, which includes modules (110, 120, 130, 140, 150) accessible by an application running on a smart device 180 such as a smart phone, laptop or a tablet. While shown outside the smart device 180, the modules (110, 120, 130, 140, 150) could be incorporated into software instructions that are resident on the smart device 180. Alternatively, some or all functions of the modules (110, 120, 130, 140, 150) could be performed externally, and accessed by the smart device 180 using conventional wireless communications from a server, website, or other accessible facility. While described and illustrated in terms of one example of functional modules, in practice the particular functions to be performed may interact and/or be integrated in a structure different from that pictured, and a system may employ modules that combine functions and/or which provide functions described as being performed by other modules. Thus, the modules used as examples should be interpreted as describing one example of how the functions may be performed by the system rather than as a map of structure for providing such functions.

In the example shown, the smart device 180 has a user interface 102 that allows the user to input data and allows the smart device 180 to display information to the user. The user interface 102 communicates with a processor 104, which in turn can access a memory 106 that can store data and instructions (which could include instructions for performing some or all of the functions of the modules (110, 120, 130, 140, 150)). The modules include a task input module 110 (one example of which is discussed further with regard to FIG. 1B), a dynamic priority module 120 (one example of which is discussed further with regard to FIG. 1C), a location-based module 130 (one example of which is discussed further with regard to FIG. 1D), a task display module 140, and a notification module 150.

FIG. 1B shows one example of the task input module 110, which directs the processor 104 to receive task data from the user interface 102. Such could be entered responsive to prompts displayed on the user interface 102. The task data is stored in a task database 112 in the memory 106 for use by the other modules (120, 130, 140, 150). Such task information may include a task type (selected from a due-by task or a do-on task), a task completion date, an initial task priority, and a task location. A number of task priority levels (for example, at least 5 levels) can be selected to allow a user to order tasks by their relative importance. Additional information could include a task category, parameters for adjusting the priority (such as a profile for how to increase the priority of a due-by task over time, proximity range for a location-based task, an instruction to override the location function to display a location-based task even when outside the usual range for display, etc.), parameters for the time that the task is expected to take to complete (which can then be used to adjust the profile for increasing priority level of a due-by task), whether the task is recurring, information on related tasks (such as where a previous task must be completed first, or where the task at hand must be completed before a further task can be undertaken), or other information that can inform the other modules in how they interact with the task. The task input module 110 may also accept task information from the other modules, such as dynamic priority module 120 to change the current priority level of the tasks, and may accept task information from other sources, such as by communication with other applications such as an existing calendar application, a shared task management application, similar systems operated by other users, etc. Where tasks are shared with other users of similar systems, the task data entered by the task input module 110 may include parameters as to whether a particular task entered is to be shared and, if so, identifying the person(s) or group(s) the task is to be shared with. The task input module 110 may also be programmed to receive a task completion status input from the user (such as by the user manually swiping a task displayed on the user interface 102), and the task input module 110 can then adjust the record of the completed task stored in the task database 112. Such adjustment could include simply marking the task as completed (if it is likely that the task information would be helpful when entering a similar task in the future), deleting the record of the task, setting a new completion date (if the task is a recurring task). Where tasks are related, such as one task having another as a pre-requisite, completion of the task could cause the task input module 110 to adjust the priority level of related tasks; for example, a 2nd task requiring completion of the current task before the 2nd task can be undertaken might have a low priority level until the 1st task is completed, and upon completion of the 1st task, the priority level of the 2nd task would be increased.

FIG. 1C shows one example of the dynamic priority module 120, which adjusts the task priority over time, at least for due-by tasks. The dynamic priority module 120 accesses information from a clock 122 associated with the processor 104 to determine the current date and/or time (for convenience, date, time, and combined date and time are hereafter discussed only in terms of date). The dynamic priority module 120 can then access the information for a particular due-by task from the task database 112, and can increase the priority level of the task based on a comparison of the stored completion date for the task and the current date. The new priority level can then be used by task display module 140 (shown in FIG. 1A) to provide an appropriate display on the user interface 102, based on the adjusted priority of the tasks. For a do-on task, the dynamic priority module 120 can compare the completion date to the current date and, if they match, direct the task display module 140 to display the task on the user interface 102, and to hide the task if the dates do not match. This could be interpreted as a 2-level scheme of increasing the priority level when the dates match, switching the level between a lower (non-displayed) level when the dates do not match, and a higher (displayed) level when the dates do match. For either type of task, a sufficiently high priority level may be used by notification module 150 (shown in FIG. 1A) to send one or more alerts to the user via the user interface 102 and/or by other communications means (such as text message, e-mail, audio tone, etc.) to inform the user that a high-priority task exists.

FIG. 1D shows one example of the location-based module 130, which activates or adjusts the priority level of tasks based on a user's proximity to the task location. The location-based module 130 accesses the current location of the user from a location data source 132, which may be any one of or combination of conventional location sources such as GPS, cellular tower identification, mapping applications, etc. For those tasks that have an associated location stored in the task database 112, the location-based module 130 can then compare the current location of the user (as provided by the location data source 132) to the task location to see whether the current location is within a prescribed distance from the task location (treated as the locations matching). The location-based module 130 can act to instruct the task display module 140 (shown in FIG. 1A) to not display a particular task unless the user is within the prescribed distance of the task location (essentially a 2-level scheme, similar to that discussed above for do-on tasks, but based on matching location rather than date). The location-based module 130 could show tasks having a priority above a prescribed threshold even when the locations do not match, or could adjust the prescribed distance based on priority, with higher priority level tasks having a larger distance for matching than lower priority level tasks. The location-based module 130 could act to instruct the dynamic priority module 120 to adjust the priority level of the task based on whether or not the locations match, by decreasing the priority of tasks with task locations that don't match, increasing the priority of tasks with matching task locations, or both. The task display module 140 can then display the list of tasks on the user interface 102 based on the adjusted priority levels. The location-based module 130 could communicate with the notification module 150 (shown in FIG. 1A) to alert the user when their current location matches one or more task locations (particularly for tasks having a priority level above a prescribed threshold).

The task display module 140 (shown in FIG. 1A) controls a display of tasks to the user via the user interface 102. The display can list the tasks based on the adjusted task priority level and, in some cases, the user's proximity to the task location. When the task input module 110 receives a task completion status, the task display module 140 can remove the completed task from display upon receiving a completed task status. The tasks may be displayed in various formats, and typically the user is allowed to select from between different formats (such as by selecting one of several tabs). One display format is to present a prioritized list of the tasks to complete on the current date, which can be ordered and/or filtered by priority level, by completion date, alphabetically, sorted or filtered by location, sorted or filtered by category, etc. In many cases, the default display is to list the tasks in order by priority level, optionally with a cutoff threshold to show only higher priority level tasks. For due-by tasks, the display may include tasks with completion dates on upcoming dates as well as those matching the current date. Another display option is to present tasks in a calendar view, showing all tasks due within a set time period such as the current day, week, or month. The calendar view could display a heat map view showing, such as by coloring, all due-by tasks and due-on tasks for each date to provide the user an overview of upcoming tasks to aid in planning how to allocate their effort.

The display presented on the user interface 102 typically includes additional presentations necessary for allowing the user to interact with the system 100, which may be controlled by the task display module 110 or by other modules, and/or by instructions stored in the memory 106. The display screens may include a display for adding new tasks and/or editing existing tasks; such display could be controlled by the task input module 110. As examples, such task add/edit screen could prompt the user to select (such as by clicking radio buttons, check boxes, moving a slider, etc.) a task type (due-by vs. do-on, which might default to due-by), an initial priority level setting, one or more options for due-by tasks as to how the dynamic priority module 120 is to dynamically adjust the priority level over time, a task completion date (which may be selected on a calendar view), a task location (which may be selected from a list of location types and/or via interaction with a mapping capability), a task category (such as from a set list with the option to manually add list entries), and any other relevant information.

In some cases, either or both of the task input module and the task display module could integrate its function fully or partially with one or more existing task management applications (such as a calendar application). Such integration could allow the user to enter task data and/or be presented with a display of data via the user interface in a format that is compatible with the interface for one or more application with which the user is already familiar. For example, an existing application for entering an event on a calendar application could allow the user the option to open the task input module to enter task data with a completion date on the selected calendar date. Similarly, the task display module could present one or more high priority level tasks to the user via entries on an existing calendar application rather than via a stand-alone display.

In some cases, the system may be made available on a purchase or subscription basis, in which case the display can include necessary screens and prompts for allowing the user to register an account and to manage their account, including purchases/subscriptions. In some cases, the system may operate in a free mode that includes advertisements on the display or which has a limited set of features. Account information (whether for a free or paid version) could include information on user communication options (such as text number, email address, etc.), specific locations (such as user home and work addresses), groups (such as groups of coworkers, family, friends, social group members, etc.) with whom some tasks may be shared, and/or any other information that may be relevant to aid the system in handling how it operates regarding particular tasks.

The notification module 150 (shown in FIG. 1A) may send alerts the user regarding a particular task, based on the adjusted task priority level and/or the user's proximity to the task location. For example, the notification module may provide an alert to the user (via the user interface 102 and/or by other communication option) when a due-by task having a sufficiently high priority level or a do-on task has a completion date that matches the current date. Such alert could be filtered by location, so as to only provide an alert if the current location of the user matches the task location within a prescribed range of distance.

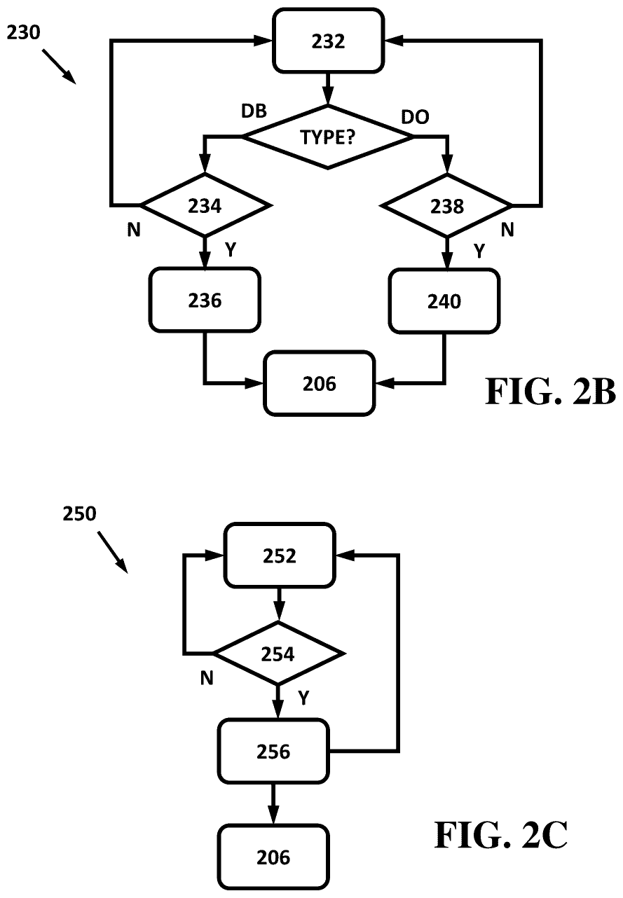

FIG. 2A is a flow chart showing an overview of one example of a method 200 for managing and prioritizing tasks, where optional steps are indicated with dashed lines. The method begins with receiving task input data (step 202), which data may include task type, initial priority level, task completion date, and/or task location. The receipt of data may include features such as discussed above with regard to the task input module 110 shown in FIGS. 1A & 1B. In step 204, the task priority level is dynamically adjusted based on passage of time (which adjustment may include features as discussed above with regard to the dynamic priority module 120 shown in FIGS. 1A & 1C) and/or current user location (which adjustment may include features as discussed above with regard to location-based module 130 shown in FIGS. 1A & 1D). At least one of the tasks is displayed to the user (step 206), and may include displaying a list of several tasks ordered by priority. As discussed above with regard to task display module 140 shown in FIG. 1A, such list could be filtered by priority level above a prescribed threshold, task completion date matching current date, current user location matching task location, and/or other relevant factors. The dynamic adjustment of priority level (step 204) and display of tasks (step 206) are repeated over time and as the user changes their current location.

Optionally, the method may include providing one or more alerts to the user (step 208) when certain conditions of time, location, and/or task priority level are met for a particular task. Such alerts may be provided in a manner including alert features as discussed above with regard to notification module 150 (shown in FIG. 1A). When the receipt of task data in step 202 includes a task category, the adjustment of priority (step 204) to determine which tasks should be displayed in step 206 could be adjusted based on category (step 210). Alternatively, such category-based filtering could be factored into the display step 206. The method may include recording a task as having been completed (step 212), which record of completion is then received as task data (step 202) for the completed task. Such recording of task completion can be performed in the manner discussed above with respect to the system 100.

FIG. 2B is a flow chart showing one example of a time-based dynamic priority level adjustment routine 230, such as may be performed under step 204 shown in FIG. 2A. The routine in step 232 accesses the current date and/or time (for convenience, discussed hereafter simply as “date”). The priority level adjustment differs for tasks that have been typed (such as in step 202 shown in FIG. 2A) as due-by tasks and for those typed as do-on tasks. For due-by tasks, the current date received in step 232 is compared to the completion date for the task (step 234) and, if appropriate (based on the time-profile set for adjusting that particular task), the priority level of the task is adjusted (step 236), typically by increasing the priority level. For do-on tasks, the current date received in step 232 is compared to the completion date for the task (step 238) and if the dates match, either the priority level of the task is increased (step 240) or the filtering of the display is adjusted to show the task, which was previously not displayed (which could be considered as a 2-level scheme that increases the priority level from low-priority/not displayed to high-priority/displayed). In either case, the new current priority level is considered when performing display of the tasks to the user in step 206.

FIG. 2C is a flow chart showing one example of a location-based dynamic priority level adjustment routine 250, such as may be performed under step 204 shown in FIG. 2A (possibly in coordination with a time-based adjustment routine such as routine 230 shown in FIG. 2B). The routine in step 252 accesses data on the current location of the user, such as could be obtained from a location data source such as source 132 discussed above). The current user location indicated in step 252 is compared to the location data for the task (step 254) to determine whether the locations match within a prescribed range of distance. Such matching could consider factors such as discussed above with regard to location-based module 130 shown in FIGS. 1A & 1D). If the locations are determined in step 154 to match within the prescribed distance, either the priority level of the task is increased (step 256) or the filtering of the display is adjusted to show the task, which was previously not displayed (which could be considered as a 2-level scheme that increases the priority level from low-priority/not displayed to high-priority/displayed). The new current priority level is then considered when performing display of the tasks to the user in step 206.

In some embodiments the method or methods described above may be executed or carried out by a computing system including a tangible computer-readable storage medium, also described herein as a storage machine, that holds machine-readable instructions executable by a logic machine (i.e. a processor or programmable control device) to provide, implement, perform, and/or enact the above described methods, processes and/or tasks. When such methods and processes are implemented, the state of the storage machine may be changed to hold different data. For example, the storage machine may include memory devices such as various hard disk drives, CD, or DVD devices. The logic machine may execute machine-readable instructions via one or more physical information and/or logic processing devices. For example, the logic machine may be programmed to execute instructions to perform tasks for a computer program. The logic machine may include one or more processors to execute the machine-readable instructions. The computing system may include a display subsystem to display a graphical user interface (GUI) or any visual element of the methods or processes described above. For example, the display subsystem, storage machine, and logic machine may be integrated such that the above method may be executed while visual elements of the disclosed system and/or method are displayed on a display screen for user consumption. The computing system may include an input subsystem that receives user input. The input subsystem may be programmed to connect to and receive input from devices such as a mouse, keyboard or gaming controller. For example, a user input may indicate a request that certain task is to be executed by the computing system, such as requesting the computing system to display any of the above described information, or requesting that the user input updates or modifies existing stored information for processing. A communication subsystem may allow the methods described above to be executed or provided over a computer network. For example, the communication subsystem may be programmed to enable the computing system to communicate with a plurality of personal computing devices. The communication subsystem may include wired and/or wireless communication devices to facilitate networked communication. The described methods or processes may be executed, provided, or implemented for a user or one or more computing devices via a computer-program product such as via an application programming interface (API).

Since many modifications, variations, and changes in detail can be made to the described embodiments of the invention, it is intended that all matters in the foregoing description and shown in the accompanying drawings be interpreted as illustrative and not in a limiting sense. Furthermore, it is understood that any of the features presented in the embodiments may be integrated into any of the other embodiments unless explicitly stated otherwise. The scope of the invention should be determined by the appended claims and their legal equivalents.

In addition, the present invention has been described with reference to embodiments, it should be noted and understood that various modifications and variations can be crafted by those skilled in the art without departing from the scope and spirit of the invention. Accordingly, the foregoing disclosure should be interpreted as illustrative only and is not to be interpreted in a limiting sense. Further it is intended that any other embodiments of the present invention that result from any changes in application or method of use or operation, method of manufacture, shape, size, or materials which are not specified within the detailed written description or illustrations contained herein are considered within the scope of the present invention.

Insofar as the description above and the accompanying drawings disclose any additional subject matter that is not within the scope of the claims below, the inventions are not dedicated to the public and the right to file one or more applications to claim such additional inventions is reserved.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

1. A task management system, comprising:
a task input module programmed to allow a user to input task data for a plurality of tasks, such task data for each task comprising,
a task type selected from the group consisting of a due-by task and a do-on task,
a task completion date/time, and
an initial task priority level;
a dynamic priority module programmed to adjust the task priority level of at least a subset of tasks to provide an adjusted task priority level for each such task based, at least partly, on the current date/time,
said dynamic priority module operating to increase the task priority level of each due-by task as the current date/time approaches the task completion date/time for such tasks,
said dynamic priority module operating to increase the task priority level of each do-on task when the current date/time matches the task completion date/time for such tasks within a specified threshold;
a task display module programmed to display at least a subset of the tasks to be completed to the user, and including at least one display mode in which at least a subset of the tasks is presented in order based on their adjusted task priority levels.

2. The system of claim 1 wherein said task input module is programmed to allow a user to input, for at least a subset of tasks, a task location, the system further comprising:
a location-based module that receives information on the current location of the user and adjusts the information provided via said task display module based, at least in part, on the current location of the user compared to the task location(s).

3. The system of claim 2 wherein, in at least one mode of operation, the information provided via said task display module is adjusted to prevent display of at least a subset of tasks having task locations that do not match the current location of the user within a prescribed threshold.

4. The system of claim 1 further comprising:
a notification module programmed to provide alerts to the user of at least one task having an adjusted task priority level that exceeds a prescribed threshold.

5. The system of claim 2 further comprising:
a notification module programmed to provide alerts to the user of at least one task having an adjusted task priority level that exceeds a prescribed threshold and having a task location that matches the current location of the user within a prescribed threshold.

6. The system of claim 1 wherein the task data input by the user includes a task category, and said task display module is programmed to display, in at least one mode of operation, at least a subset of tasks based on at least one task category.

7. The system of claim 1 wherein said task input module is further programmed to allow a user to input a task completion status with respect to each task, and said task display module is further programmed to display, in at least one mode of operation, at least a subset of tasks which excludes from display any tasks having a completed task status.

8. A task management system, comprising:
a task input module programmed to allow a user to input task data for a plurality of tasks, such task data for each task comprising,
an initial task priority level,
said task input module also allowing a user to input, for at least a subset of tasks, an associated task location;
a location-based module that receives information on the current location of the user;
a dynamic priority module programmed to adjust the task priority level of at least a subset of tasks to provide an adjusted task priority level for each task having an associated task location, based at least in part on a comparison of the current location of the user with the task location;
said dynamic priority module operating to increase the task priority level of each task having an associated location when the current location of the user matches the task location within a prescribed threshold;
a task display module programmed to display at least a subset of the tasks to be completed to the user, and including at least one display mode in which at least a subset of the tasks is presented in order based on their adjusted task priority levels.

9. The system of claim 8 wherein, in at least one mode of operation, the information provided via said task display module is adjusted to prevent display of at least a subset of tasks having task locations that do not match the current location of the user within a prescribed threshold.

10. The system of claim 8 wherein said task input module is programmed to allow a user to input, for at least a subset of tasks, a task completion date/time and a task type selected from the group consisting of a due-by task and a do-on task, further wherein said dynamic priority module is programmed to adjust the task priority level of at least a subset of tasks to provide an adjusted task priority level for each such task based, at least partly, on the current date/time,
said dynamic priority module operating to increase the task priority level of each due-by task as the current date/time approaches the task completion date/time for such tasks,
said dynamic priority module operating to increase the task priority level of each do-on task when the current date/time matches the task completion date/time for such tasks within a specified threshold.

11. The system of claim 8 further comprising:
a notification module programmed to provide alerts to the user of at least one task having an adjusted task priority level that exceeds a prescribed threshold.

12. The system of claim 8 wherein the task data input by the user includes a task category, and said task display module is programmed to display, in at least one mode of operation, at least a subset of tasks based at least in part on at least one task category.

13. The system of claim 8 wherein said task input module is further programmed to allow a user to input a task completion status with respect to each task, and said task display module is further programmed to display, in at least one mode of operation, at least a subset of tasks which excludes from display any tasks having a completed task status.

14. A method comprising the steps of:
receiving input that includes task data for a plurality of tasks, such task data for each task comprising,
a task completion date/time,
an initial task priority level,
at least one task priority adjustment criterion selected from the group of,
a task type selected from the group consisting of a due-by task and a do-on task,
a task location;
adjusting the task priority level of at least a subset of tasks to provide an adjusted task priority level for each such task based, at least partly, on the at least one task priority adjustment criterion for each such task, such adjustment including at least one adjustment from the group of:
increasing the task priority level of each due-by task as the current date/time approaches the task completion date/time for such tasks,
increasing the task priority level of each do-on task when the current date/time matches the task completion date/time for such tasks within a specified threshold, and
increasing the task priority level of each task having an associated location when the current location of the user matches the task location within a prescribed threshold; and
displaying to the user at least a subset of the tasks to be completed, such display providing, in at least one display mode, at least a subset of the tasks is presented based on their adjusted task priority levels.

15. The method of claim 14 wherein the task data received in said step of receiving input from a user includes a task location for at least a subset of the tasks, further wherein said step of displaying to the user at least a subset of the tasks includes, in at least one mode of operation, excluding from display at least a subset of tasks having task locations that do not match the current location of the user within a prescribed threshold.

16. The method of claim 14 further comprising the step of:
providing alerts to the user of at least one task having an adjusted task priority level that exceeds a prescribed threshold.

17. The method of claim 15 further comprising the step of:
providing alerts to the user of at least one task having an adjusted task priority level that exceeds a prescribed threshold and having a task location that matches the current location of the user within a prescribed threshold.

18. The method of claim 14 wherein the task data input by the user includes a task category, and said step of displaying to the user at least a subset of the tasks includes, in at least one mode of operation, adjusting the display based on at least one task category.

19. The method of claim 14 further comprising the step of:
allowing a user to input a task completion status with respect to each task, further wherein said step of displaying to the user at least a subset of the tasks includes, in at least one mode of operation, excluding from display any tasks having a completed task status.
